(19) United States
(12) Patent Application Publication
(10) Pub. No.: US 2011/0180742 A1
(43) Pub. Date: Jul. 28, 2011

(54) Valve Having a Long Average Operating Life

(75) Inventors: Thomas Uhland, Pfaffenhofen (DE); Friedbert Roether, Cleebronn (DE)

(73) Assignee: KNORR-BREMSE Systeme fuer Nutzfahrzeuge GmbH, Muenchen (DE)

(21) Appl. No.: 12/987,563

(22) Filed: Jan. 10, 2011

Related U.S. Application Data
(63) Continuation of application No. PCT/EP2009/004861, filed on Jul. 6, 2009.

(30) Foreign Application Priority Data
Jul. 11, 2008 (DE) 10 2008 032 716.6

(51) Int. Cl. F16K 27/00

(52) U.S. Cl. 251/366

(57) ABSTRACT

A valve has a vale body that is movable in a valve housing opposite a valve seat. A space is formed between the valve body and the valve housing. The space is partitioned or limited by way of at least one seal. The at least one seal has a carrier element made from metal.

### CROSS-REFERENCE TO RELATED APPLICATIONS

This application is a continuation of PCT International Application No. PCT/EP2009/004861, filed Jul. 6, 2009, which claims priority under 35 U.S.C. §119 from German Patent Application No. DE 10 2008 032 716.6, filed Jul. 11, 2008, the entire disclosures of which are herein expressly incorporated by reference.

### BACKGROUND AND SUMMARY OF THE INVENTION

The invention relates to a valve having a valve body which is movable in a valve housing with respect to a valve seat, a space being formed between the valve body and the valve housing and being subdivided or delimited by means of at least one seal.

Valves, in particular pneumatic valves, usually have a plurality of seals for separating individual working chambers or individual operating spaces between a movable valve body and a valve housing, or for sealing the valve housing. The seals are generally implemented in the form of O-rings or of applied molded seals made of elastomeric materials in each case. However, elastomeric materials are subject to an ageing process which leads, among other things, to a slackening of their restoring capability, with resulting leakage of the seal under load.

Especially in the field of commercial vehicles, robustness and long service life, that is, a long average operating life, are an important prerequisite for operation. Average operating life is understood here in general terms to mean the operating life from first putting the valve into operation to the first defect resulting in failure, wherein a shifting error as a result of slackening of the sealing effect also is evaluated as a failure. In particular, valve seals which are constantly under pressure or constantly exposed to high temperatures or temperature changes have difficulty in meeting the demands placed on them regarding robustness and service life, so that shortened maintenance intervals or, in the event of a defect, shifting errors may be the result.

It is therefore the object of the present invention to provide a valve which meets relatively high demands with regard to service life and which has a relatively long average operating life when operated at elevated temperatures or with constant temperature changes.

The invention provides a valve having a body which is movable in a valve housing with respect to a valve seat wherein a space is formed between the valve body and the valve housing. The space is subdivided or partitioned by at least one seal, wherein the seal includes a carrier element made of metal.

The use of a seal having a carrier element made from metal permits permanently elastic sealing, it being possible to increase the elasticity further by the use of a spring steel as the carrier element. Such a seal has relatively slight setting behavior and long service life, and is permanently suitable for high temperatures. According to the present invention, therefore, seals which have been produced hitherto from an elastomeric material are to be at least partially replaced in the valve by metal seals, that is, seals which are produced at least partially from a metal.

In particular, it may be provided that the at least one seal is produced entirely from metal. If the at least one seal is produced entirely from metal, the seal has especially high temperature stability, as compared to a seal produced from an elastomer, whereby the average operating life when operating under high ambient temperatures is increased.

Alternatively, it may be provided that the at least one seal includes a coating made from an elastomer. If the seal has a coating made from an elastomer surrounding the carrier element, the sealing effect is comparable to that of a seal produced entirely from an elastomer, but has higher temperature stability and a longer service life in comparison thereto. This can be explained, in particular, by the non-ageing carrier element made from metal.

It is especially preferred that the metal carrier element has at least one bead as a resilient element. A bead, that is, a channel-shaped depression or elevation, can be used to compensate for unevenness of the movable valve body, for example a movable magnet, and of the valve housing. In this way, a lastingly adequate sealing effect can be generated.

Furthermore, it may be provided that the at least one seal includes a plurality of sealing layers which are arranged in a non-parallel manner with respect to the sealing direction. Through the use of a plurality of sealing layers arranged one above the other and non-parallel to the sealing direction, the sealing effect of the individual seals can be improved. In this case the arrangement of the sealing layers may preferably be perpendicular to the sealing direction.

It is preferably provided that the at least one seal subdivides the space multiple times at different sealing locations. Through the use of a single component which makes possible sealing at a plurality of different sealing locations, simplified assembly of the valve can be achieved.

It is usefully provided in this connection that the valve body is built up from a plurality of parts which are movable independently of one another and that the sealing locations are arranged on different, independently movable parts of the valve body. The component used may provide a sealing effect simultaneously on a plurality of separately movable components of the valve body.

It may also be provided that the space formed between the valve housing and valve body is further subdivided by an O-ring and/or an applied molded seal, the O-ring and/or the molded seal consisting of an elastomer. Depending on the application of the valve, it may be advantageous to replace only some of the seals present in the valve by a seal with a carrier element of metal, and to continue to produce the other seals in the conventional fashion from an elastomeric material. This allows known manufacturing methods to be used and, especially if not all the seals of the valve are exposed to elevated stresses, is not disadvantageous with regard to average operating life.

It may be provided that the valve is a 2/2-way valve. A 2/2-way valve is a frequently-used valve which is also used in environments unfavorable to the service life of the valve.

Alternatively, it may also be provided that the valve is a 3/2-way valve. 3/2-way valves are also frequently used in environments unfavorable to service life.

In connection with the present invention, it is especially advantageous if a pneumatic transmission control system is equipped with at least one valve according to the invention. Because of frequent shifting processes, high operating temperatures or constant temperature fluctuations with high shifting pressures acting on the valves of the pneumatic transmission control system, the pneumatic transmission control system is especially dependent on valves with a long average operating life. A pneumatic transmission control system therefore places high demands on the valves used.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first embodiment of a valve according to the invention;

FIG. 2 shows a second embodiment of a valve according to the invention;

FIG. 3 shows a third embodiment of a valve according to the invention; and

FIG. 4 shows a cross section through a seal.

### DETAILED DESCRIPTION OF THE DRAWINGS

In the drawings the same reference symbols denote identical parts or parts of the same kind.

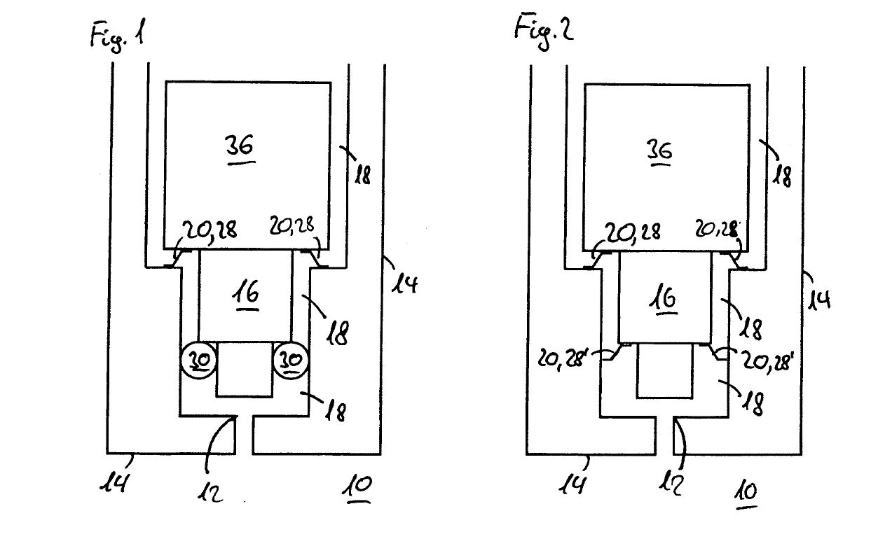

FIG. 1 shows a first embodiment of a valve according to the invention. The valve 10 represented includes a valve housing 14 with a valve seat 12. A valve body 16, which is movable with respect to the valve housing 14, is located in the interior of the valve housing 14. The upper part of the movable valve body is in the form of an electromagnetic actuating device 36. The electromagnetic actuating device 36 may be in the form, for example, of a simple permanent magnet and, through energization of a coil winding (not shown) which is arranged on the valve housing 14, is able to exert a force in order to move the valve body 16. A space 18, which is subdivided or partitioned into a plurality of regions by a seal 20 at a sealing location 28 and by an O-ring 30, is formed between the valve body 16 and the valve housing 14. In this case, the O-ring 30 may usually be produced from an elastomeric material.

The seal 20 arranged at the sealing location 28 includes at least one carrier element made of metal, which may be produced, for example, from a spring steel. The seal 20 equipped with the metal carrier element 22 is tensioned between the valve housing 14 and the valve body 16, so that a pressure force between the two parts holds the seal in the prescribed position and establishes the gas-tight connection between the seal 20 and the valve housing 14 and the valve body 16.

The seal 20 may be embodied, for example, as a metal bead seal, that is, as an elastomer-coated sheet metal carrier. In such an embodiment, the seal has a defined, elastic sealing geometry whereby it preserves a long-lasting sealing effect which can be further improved by the use of spring steel. The sealing effect may be obtained, for example, by a bead, that is, a channel-shaped depression or elevation, in the seal 20, in particular in the sheet metal carrier. The bead acts as a resilient element of the seal 20 and compensates for unevenness of the movable valve body 16 and of the valve housing 14.

The subdivision of the space 18 into a plurality of mutually sealed regions produces a plurality of working chambers or operating spaces separate from one another, which can each make available working surfaces for the pneumatic activation of the valve 10, the pneumatic control lines and connections not being represented in all of the drawings for the sake of simplicity. However, the different working chambers or operating spaces may also, in different positions of the valve body 16, open different compressed air connections associated with the individual positions. For simplicity, connecting lines necessary for this purpose are likewise not shown.

Through the use of a metal carrier element with appropriate shaping, the necessary overall height in the region of the sealing location 28 can be reduced, as compared to a conventional elastomer seal, whereby the overall length of the valve 10 can be reduced. It is also possible for the seal 20 to delimit the entire space 18, so that it is responsible for sealing the space 18 from the outside, and in this case is arranged, for example, between two separate housing parts of the valve housing 14. It is further possible that the valve body 16 is built up from a plurality of components which are movable independently of one another, for example a plurality of magnets which are not in direct contact with one another. In this case the space 18 enclosed between valve housing 14 and valve body 16 may not be simply continuous, and may be further subdivided multiple times at different locations by the seal 20 into non-continuous regions of the space 18.

FIG. 2 shows a second embodiment of a valve according to the invention. In contrast to the embodiment of the valve 10 represented in FIG. 1, in the embodiment represented in FIG. 2 the O-ring 30 known from FIG. 1 has been replaced at a sealing location 28′ by a seal 20 which also has a carrier made of metal. The embodiment represented in FIG. 2 therefore includes only seals 20 having a metal carrier.

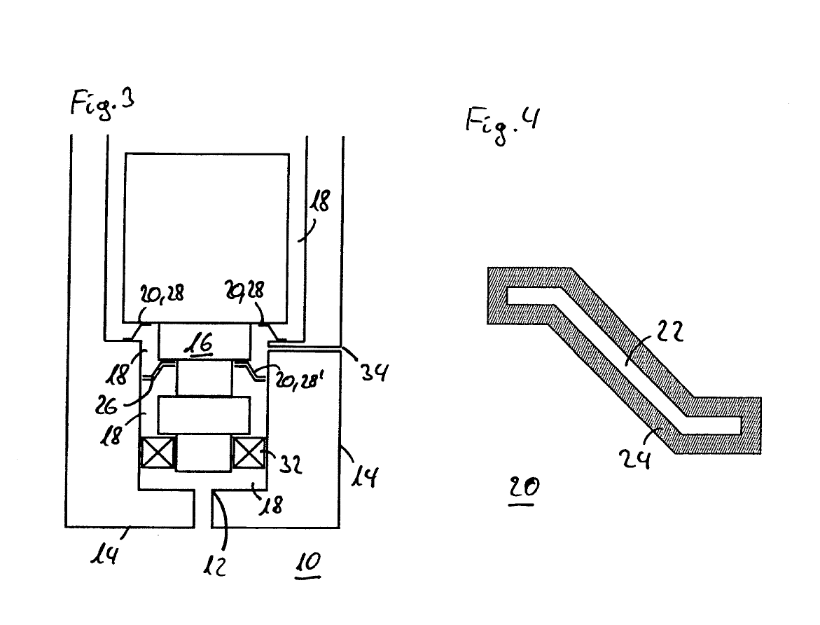

FIG. 3 shows a third embodiment of a valve according to the invention. In the embodiment of the valve 10 represented in FIG. 3, the seal 20 at the sealing location 28′ is embodied with two sealing layers 26 disposed one above the other perpendicularly to the sealing direction. This may be used, for example, in order to improve the sealing effect of the seal 20. In addition, a molded seal 32 made from an elastomeric material is arranged at the end of the valve body 16 oriented towards the valve seat of the valve 10. A part of the space 18 lying between the sealing location 28 and the sealing location 28′ can be charged with control air via a connection 34. In this way a force can be exerted via control surfaces on the valve body 16 in order to move the valve body within the valve housing 14. The use or provision of further actuating devices, for example the electromagnetic actuating device known from FIGS. 1 and 2 or a return spring, is possible.

FIG. 4 shows a cross section through a seal. The seal 20 has a carrier element 22 made of metal and a coating 24 which at least partially envelops the carrier element 22. The carrier element 22 may be produced, for example, from a spring steel, so that a sealing effect can be achieved at the sealing location as a result of the shape and arrangement of the seal. The carrier element 22 is a prerequisite for a permanent elasticity of the seal 20. However, a simple bead in the carrier element 22 (not shown in this figure) can be an essential basis for the permanently elastic sealing effect. In particular, the carrier element 22 does not age, or does not age prematurely, if the seal is continuously under pressure or is exposed to high operating temperatures or large temperature changes. The coating 24 may be, for example, a thin elastomer layer in order to improve the sealing effect of the seal 20 at the sealing locations 28, 28′ known from FIGS. 1 to 3.

The valve according to the invention is especially stable and robust, so that it is used particularly appropriately in vehicle technology where special importance is attached to long average operating life. In this case the use of the valve at locations in the vehicle which attain high temperatures during operation is especially preferred. In particular, a pneumatic transmission control system of the vehicle should be mentioned in this context.

Table of Reference Numerals

| | |
|---|---|
| 10 | Valve |
| 12 | Valve seat |
| 14 | Valve housing |
| 16 | Valve body |
| 18 | Space |
| 20 | Seal |
| 22 | Carrier element |
| 24 | Coating |
| 26 | Sealing layer |
| 28 | Sealing location |
| 28′ | Sealing location |
| 30 | O-ring |
| 32 | Molded seal |
| 34 | Connection for control air |
| 36 | Electromagnetic actuating device |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A valve, comprising:
a valve housing;
a valve body movable in the valve housing;
at least one seal operatively configured to partition a space between the valve body and the valve housing; and
wherein the at least one seal comprises a metal carrier element.

2. The valve according to claim 1, wherein the at least one seal is entirely made of metal.

3. The valve according to claim 1, wherein the carrier element of the seal has an elastomer coating.

4. The valve according to claim 1, wherein the metal carrier element comprises at least one bead providing resiliency.

5. The valve according to claim 3, wherein the metal carrier element comprises at least one bead providing resiliency.

6. The valve according to claim 1, wherein the seal comprises a plurality of sealing layers arranged in a non-parallel manner relative to a sealing direction.

7. The valve according to claim 1, wherein the at least one seal is operatively configured to subdivide the space multiple times at different sealing locations.

8. The valve according to claim 7, wherein the valve body is constructed of a plurality of parts movable independently of one another; and
wherein the different sealing locations are arranged on different parts of the valve body that are movable independently of one another.

9. The valve according to claim 1, further comprising:
at least one of an O-ring and an applied molded seal operatively arranged to further subdivide the space between the valve housing and the valve body, said O-ring or applied molded seal being made of an elastomer.

10. The valve according to claim 1, wherein the valve is a 2/2-way valve.

11. The valve according to claim 1, wherein the valve is a 3/2-way valve.

12. A vehicle system, comprising:
a pneumatic transmission control system comprising a valve; and
wherein the valve comprises:
a valve housing;
a valve body movable in the valve housing;
at least one seal operatively configured to partition a space between the valve body and the valve housing; and
wherein the at least one seal comprises a metal carrier element.

13. The system according to claim 12, wherein the at least one seal is entirely formed of metal.

14. The system according to claim 12, wherein the at least one seal comprises an elastomer coating on the metal carrier element.
